(19) United States
(12) Patent Application Publication
(10) Pub. No.: US 2009/0082152 A1
(43) Pub. Date: Mar. 26, 2009

(54) Vehicular driving power distribution device

(76) Inventor: Yoshihiro Ikushima, Aichi-ken (JP)

Correspondence Address: KENYON & KENYON LLP, 1500 K STREET N.W., SUITE 700, WASHINGTON, DC, 20005, US

(21) Appl. No.: 11/918,408

(22) PCT Filed: Dec. 1, 2006
(86) PCT No.: PCT/IB2006/004039

§ 371 Date: Oct. 12, 2007

(30) Foreign Application Priority Data
Dec. 2, 2005 (JP) 2005-349437

(51) Int. Cl. B60W 10/12; F16H 48/06

(52) U.S. Cl. 475/5; 475/150; 475/84

(57) ABSTRACT

A driving power distribution device includes a propeller shaft that transmits the driving power generated by an engine, a differential device having a planetary gear device that is provided concentrically with the axial center of rotation of the propeller shaft, and a hydraulic motor fixed to the propeller shaft. The ring gear of the planetary gear device is coupled to the propeller shaft. The carrier is connected to a right rear wheel. The sun gear is connected to a left rear wheel. Inner pinions of the planetary gear device are driven by the hydraulic motor. Therefore, while the driving power generated by the engine is being distributed to the right and left rear wheels, a control of generating a desired torque difference or restricting the differential motion can be performed. Also, the actuator torque capacity can be reduced, so that size reduction of the device is made possible.

### BACKGROUND OF THE INVENTION

1. Field of the Invention

The invention relates to an improvement in a vehicular driving power distribution device that distributes the driving power generated by a driving power source to right and left driving wheels.

2. Description of the Related Art

Vehicular driving power distribution devices that distribute the driving power generated by a driving power source to right and left driving wheels are known. Examples of the devices are driving power distribution control devices described in Japanese Patent Application Laid-Open Publication HEI 7-164852 and Japanese Patent Application Publication JP-A-2001-39179. According to a technology disclosed in Japanese Patent Application Laid-Open Publication HEI 7-164852, by individually controlling the clutching forces of clutches that are provided corresponding to right and left driving wheels, respectively, the driving power can be distributed to the right and left driving wheels at an arbitrary ratio so that a desired torque difference can be generated between the right and left driving wheels.

However, the above-described related art has a drawback that a sufficient torque difference cannot be generated between the right and left driving wheels when the input driving power is relatively small. Besides, in a type of driving power distribution device in which the entire driving power generated by the driving power source is distributed via engagement elements that correspond to the individual driving wheels, the engagement elements, which carry out the distribution, inevitably bear the entire driving power, thus resulting in a problem of an -increased size of the device. Therefore, a simply constructed vehicular driving power distribution device capable of suitably distributing the driving power to the right and left driving wheels has been demanded.

### SUMMARY OF THE INVENTION

The invention has been accomplished against the background of the aforementioned circumstances, and provides a simply constructed vehicular driving power distribution device capable of suitably distributing the driving power to right and left driving wheels.

Accordingly, there is provided a vehicular driving power distribution device that distributes driving power generated by a driving power source to right and left driving wheels, characterized by including: a driving power transmission shaft that transmits the driving power generated by the driving power source and that is disposed so that an axis of rotation of the driving power transmission shaft is orthogonal to an axis of rotation of each of the right and left driving wheels; a differential device having a planetary gear device that has a first rotating element, a second rotating element and a third rotating element and that is provided concentrically with an axial center of rotation of the driving power transmission shaft; and a motor fixed to the driving power transmission shaft, wherein the first rotating element of the planetary gear device is coupled to the driving power transmission shaft, and the second rotating element is connected to one of the right and left driving wheels, and the third rotating element is connected to another one of the right and left driving wheels, and pinions of the planetary gear device are driven by driving power generated by the motor.

According to the vehicular driving power distribution device described above, the device includes: a driving power transmission shaft that transmits the driving power generated by the driving power source and that is disposed so that an axis of rotation of the driving power transmission shaft is orthogonal to an axis of rotation of each of the right and left driving wheels; a differential device having a planetary gear device that has a first rotating element, a second rotating element and a third rotating element and that is provided concentrically with an axial center of rotation of the driving power transmission shaft; and a motor fixed to the driving power transmission shaft. The first rotating element of the planetary gear device is coupled to the driving power transmission shaft, and the second rotating element is connected to one of the right and left driving wheels, and the third rotating element is connected to another one of the right and left driving wheels, and pinions of the planetary gear device are driven by driving power generated by the motor. Therefore, while the driving power generated by the driving power source is being distributed to the right and left driving wheels via the differential device, a control of, for example, generating a desired torque difference between the right and left driving wheels or restricting the differential motion therebetween by using the driving power generated by the motor, can be performed. At the same time, the actuator torque capacity can be reduced, so that size reduction of the device is made possible. That is, a simply constructed vehicular driving power distribution device capable of suitably distributing the driving power to the right and left driving wheels can be provided.

Preferably, in the planetary gear device, the first rotating element is a ring gear, and the second rotating element is a carrier that supports a plurality of pinions, and the third rotating element is a sun gear.

According to the vehicular driving power distribution device described above, while the driving power generated by the driving power source is being distributed to the right and left driving wheels via the differential device constructed in a practical fashion, a control of, for example, generating a desired torque difference between the right and left driving wheels or restricting the differential motion therebetween by using the driving power generated by the motor, can be performed.

Also preferably, the planetary gear device is a double-pinion type planetary gear device, and the motor drives inner pinions that constitute the pinions of the planetary gear device. Besides, it is also preferable that a rotor of the motor be coupled to an output gear, and that the output gear drive the inner pinions. The output gear may be an external gear, or an internal gear.

According to the vehicular driving power distribution device described above, while the driving power generated by the driving power source is being distributed to the right and left driving wheels via the differential device constructed in a practical fashion, a control of, for example, generating a desired torque difference between the right and left driving wheels or restricting the differential motion therebetween by using the driving power generated by the motor, can be performed.

Besides, preferably, the second rotating element and the third rotating element are connected to the right and left driving wheels via speed reducer devices, respectively. According to the vehicular driving power distribution device described above, the driving powers distributed by the differential device can be suitably transmitted to the right and left driving wheels.

Besides, preferably, each speed reducer device performs speed reduction via a hypoid gear pair. According to the vehicular driving power distribution device described above, the driving powers distributed by the differential device can be further suitably transmitted to the right and left driving wheels.

Besides, preferably, each speed reducer device performs speed reduction via a gear pair, and then further performs speed reduction via a hypoid gear pair. According to the vehicular driving power distribution device described above, the driving powers distributed by the differential device can be further suitably transmitted to the right and left driving wheels.

Besides, preferably, the motor is a hydraulic motor. According to the vehicular driving power distribution device described above, a control of, for example, generating a desired torque difference between the right and left driving wheels or restricting the differential motion therebetween by using the driving power generated by the practical motor, can be performed.

Besides, preferably, the motor is an electric motor. According to the vehicular driving power distribution device described above, a control of, for example, generating a desired torque difference between the right and left driving wheels or restricting the differential motion therebetween by using the driving power generated by the practical motor, can be performed.

Besides, preferably, torque distribution to the right and left driving wheels can be controlled by controlling the driving power generated by the motor. According to the vehicular driving power distribution device described above, a desired torque Difference can be generated between the right and left driving wheels through a simple control.

Besides, preferably, differential motion between the right and left driving wheels is restricted by braking the motor. According to the vehicular driving power distribution device described above, the restriction of the differential motion between the right and left driving wheels can be realized through a simple control.

### BRIEF DESCRIPTION OF THE DRAWINGS

The features, advantages thereof, and technical and industrial significance of this invention will be better understood by reading the following detailed description of preferred embodiments of the invention, when considered in connection with the accompanying drawings, in which:

FIG. 1 is a skeleton diagram illustrating a construction of a front-rear-wheel drive vehicle based on a front-mounted engine front wheel drive system which has a driving power transmission device of a first embodiment to which the invention is suitably applied;

FIG. 2 is a skeleton diagram illustrating a construction of the driving power distribution device of the first embodiment of the invention;

FIG. 3 is a diagram illustrating an action of generating a desired torque difference between right and left rear wheels via a planetary gear device by using the driving power generated by a hydraulic motor in the driving power distribution device shown in FIG. 2;

FIG. 4 is a skeleton diagram illustrating a construction of a front-rear-wheel drive vehicle that has a driving power distribution device of a second embodiment of the invention;

FIG. 5 is a skeleton diagram illustrating a construction of the driving power distribution device of the second embodiment of the invention; and

FIG. 6 is a skeleton diagram illustrating a construction of a driving power distribution device of a third embodiment of the invention.

### DETAILED DESCRIPTION OF THE PREFERRED EMBODIMENTS

In the following description and the accompanying drawings, the present invention will be described in more detail with reference to exemplary embodiments.

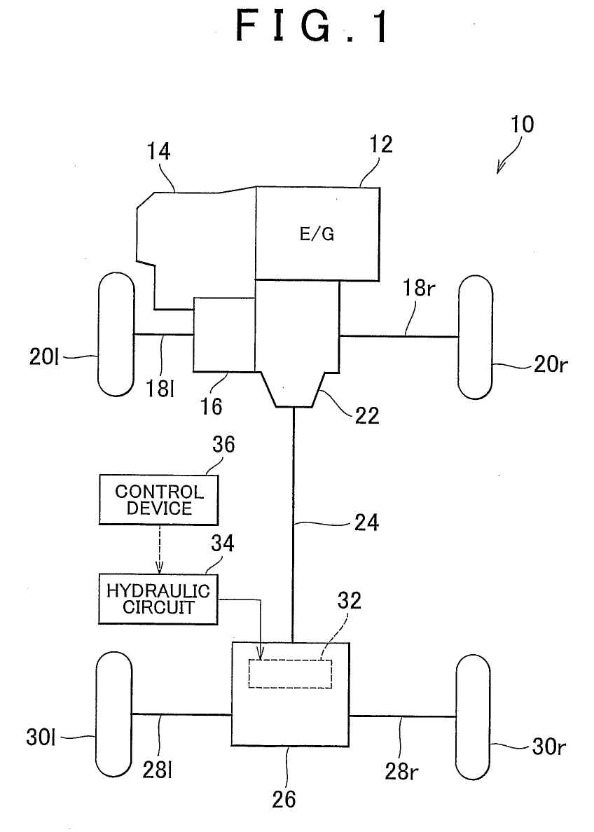

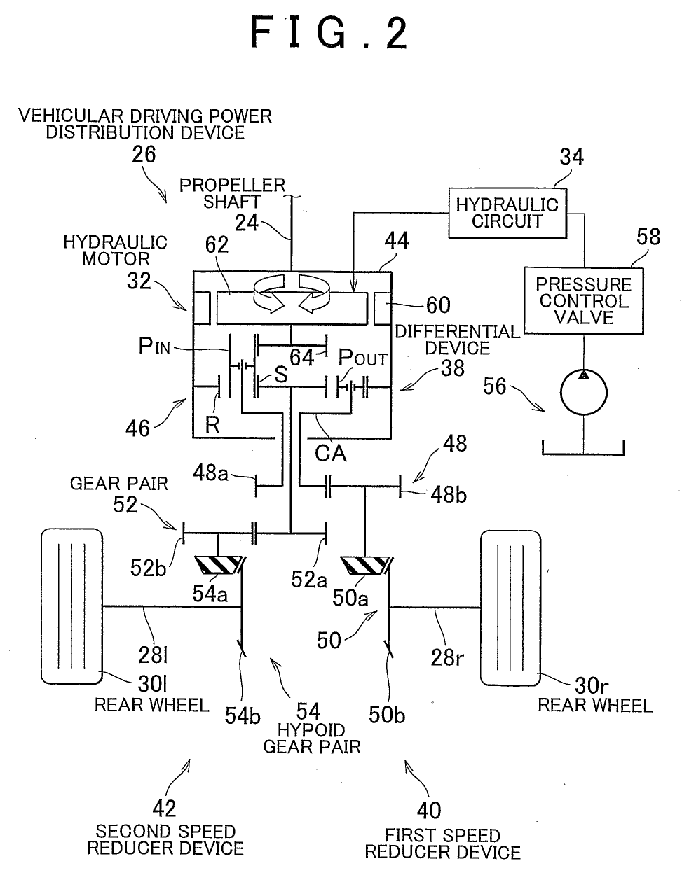

FIG. 1 is a skeleton diagram illustrating a construction of a front-rear-wheel drive vehicle based on a front-mounted engine front wheel drive (FF) system which has a driving power transmission device 10 of a first embodiment to which the invention is suitably applied. In FIG. 1, the driving power (torque) generated by an engine 12 that is a driving power source is transmitted, on one hand, to a pair of right and left front wheels 20r, 20l (hereinafter, simply referred to as “front wheels 20” if not particularly distinguished) via an automatic transmission 14, a front wheel-purpose differential gear device 16, and a pair of right and left front wheel axle shafts 18r, 18l (hereinafter, simply referred to as “front wheel axle shafts 18” if not particularly distinguished). On the other hand, the driving power is also transmitted to a pair of right and left rear wheels 30r, 30l (hereinafter, simply referred to as “rear wheels 30” if not particularly distinguished) via a central differential gear device (center differential) 22, a propeller shaft 24 that is a driving power transmission shaft, a vehicular driving power distribution device (hereinafter, simply referred to as “driving power distribution device”) 26 that is an embodiment of the invention as an example, and a pair of right and left rear wheel axle shafts 28r, 28l (hereinafter, simply referred to as “rear wheel axle shafts 28” if not particularly distinguished). It is to be noted herein that as shown in FIG. 1, in the driving power transmission device 10 of the first embodiment, the axis of rotation of each of the rear wheels 30 as driving wheels concerned with the distribution of driving power carried out by the driving power distribution device 26 and the axis of rotation of the propeller shaft 24 are orthogonal to each other. Besides, a hydraulic motor 32 is provided within a case 44 (see FIG. 2) of the driving power distribution device 26. One of a stator (stationary element) and a rotor (rotary element) of the hydraulic motor 32 (the stator in this embodiment) is coupled to the propeller shaft 24. The driving power transmission device 10 is provided with a hydraulic circuit 34 that controls, for example, the oil pressure supplied to the hydraulic motor 32, and a control device 36 that controls, for example, the oil pressure supplied to the hydraulic motor 32 from the hydraulic circuit 34 via an electromagnetic control valve or the like (not shown) that is provided in the hydraulic circuit 34. Incidentally, in FIG. 1, the oil pressure output from the hydraulic circuit 34 is represented by an arrow with a fine solid line, and a control command output from the control device 36 is represented by an arrow with a find broken line.

The engine 12 is, for example, an internal combustion engine such as a gasoline engine that generates driving power through the combustion of fuel injected into the cylinders, a diesel engine, etc. Besides, the automatic transmission 14 is, for example, a stepped automatic transmission that reduces or increases the speed of rotation input from the engine 12 at predetermined speed change ratios y and outputs the thus-speed-changed rotation. In the automatic transmission 14, one of forward travel speed change steps, a reverse travel speed change step and a neutral state is selectively established, and the speed conversion in accordance with the speed change ratio y of the established gear step is performed. Incidentally, an input shaft of the automatic transmission 14 is coupled to an output shaft of the engine 12 via a torque converter (not shown) or the like.

The control device 36 is a so-called microcomputer that includes a CPU, a ROM, a RAM, an input/output interface, etc., and that executes signal processing in accordance with programs pre-stored in the ROM while utilizing the temporary storage function of the RAM. For example, the control device 36 executes a right-left wheel torque difference control (described below), a differential motion restriction control (described below), etc., by controlling the designated value of the current supplied to the electromagnetic control valve provided in the hydraulic circuit 34 so as to control the oil pressure that is supplied to the hydraulic motor 32 in the driving power distribution device 26 in order to drive the hydraulic motor 32. Besides, the driver power transmission device 10 is provided with a wheel speed sensor that detects the actual rotation speed of the rear wheels 30 that corresponds to the vehicle speed, a shift gear step sensor that detects the speed change step of the automatic transmission 14, a throttle sensor that detects the actual degree of opening of a throttle valve (not shown) that is provided in an intake/exhaust pipe of the engine 12, an engine rotation speed sensor that detects the actual rotation speed of the engine 12, a longitudinal G sensor, etc. These sensors supply a signal that represents the vehicle speed, a signal that represents the shift gear step, a signal that represents the degree of throttle opening, a signal that represents the engine rotation speed, and a signal that represents the longitudinal acceleration, etc., to the electronic control device 36.

FIG. 2 is a skeleton diagram illustrating a construction of the driving power distribution device 26. As shown in FIG. 2, the driving power distribution device 26 of the first embodiment includes a differential device 38 that distributes the driving power generated by the engine 12 and transmitted thereto via the propeller shaft 24 into the right and left rear wheels 30, a first speed reducer device 40 that reduces the speed of the driving power distributed by the differential device 38 corresponding to the right rear wheel 30r and that transmits the speed-reduced driving power to the right rear wheel 30r, and a second speed reducer device 42 that reduces the speed of the driving power distributed by the differential device 38 corresponding to the left rear wheel 301 and that transmits the speed-reduced driving power to the left rear wheel 30l. Herein, the case 44 of the differential device 38 is coupled to the propeller shaft 24. The driving power transmitted by the propeller shaft 24 is input to a planetary gear device 46 (described below) via the case 44.

The differential device 38 includes the planetary gear device 46 that is rotatable about the axis of rotation of the propeller shaft 24. The planetary gear device 46 is a double-pinion type planetary gear device that includes a ring gear R that is a first rotating element, inner pinions P_{IN} and outer pinions P_{OUT} that mesh with each other (hereinafter, simply referred to as “pinions P” if not particularly distinguished), a carrier CA that is a second rotating element and that supports the pinions P so that the pinions P are rotatable about their own axes and also are revolvable, and a sun gear S that is a third rotating element and that meshes with the ring gear R via the pinions P. The gear ratio p (the number of teeth Zs of the sun gear S/the number of teeth Zr of the ring gear R) thereof is 0.5. The ring gear R is provided within the case 44 of the differential device 38, integrally with the case 44. That is, the ring gear R is coupled to the propeller shaft 24 via the case 44. Besides, the carrier CA is connected to the right rear wheel 30r via the first speed reducer device 40 and the rear wheel axle shaft 28r. Besides, the sun gear S is connected to the left rear wheel 30l via the second speed reducer device 42 and the rear wheel axle shaft 28l. Incidentally, due to the construction of the planetary gear device 46, the second rotating element and the third rotating element are interchangeable, which applies to the following description.

The first speed reducer device 40 includes a gear pair 48 made up of a pair of gears 48a, 48b that mesh with each other, and a hypoid gear pair 50 made up of a pair of a small gear 50a and a large gear 50b that mesh with each other. Of the gear pair 48, a gear 48a (input-side gear) is coupled to the carrier CA of the planetary gear device 46, and the other gear 48b (output-side gear) is coupled to the small gear 50a of the hypoid gear pair 50. Besides, the large gear 50b of the hypoid gear pair 50 is coupled to the rear wheel 30r as a driving wheel, via the rear wheel axle shaft 28r. Besides, the second speed reducer device 42 includes a gear pair 52 made up of a pair of gears 52a, 52b that mesh with each other, and a hypoid gear pair 54 made up of a pair of small gear 54a and a large gear 54b that mesh with each other. Of the gear pair 52, a gear 52a (input-side gear) is coupled to the sun gear S of the planetary gear device 46, and the other gear 52b (output-side gear) is coupled to the small gear 54a of the hypoid gear pair 54. Besides, the large gear 54b of the hypoid gear pair 54 is coupled to the rear wheel 30l as a driving wheel, via the rear wheel axle shaft 28l. Herein, it is not altogether necessary that the first speed reducer device 40 and the second speed reducer device 42 have the same speed reduction ratio, but it is possible to appropriately determine a suitable speed reduction ratio for each of the two devices so that torque is equally distributed to the right and left rear wheels 30.

The hydraulic motor 32 is, for example, a motor that is driven by the oil pressure generated by a hydraulic pump 56 having a pump impeller that is coupled to a crankshaft of the engine 12. The oil pressure generated by the hydraulic pump 56 is regulated by a pressure control valve 58, and then is supplied to the hydraulic motor 32 via the hydraulic circuit 34. The control device 36 controls the oil pressure supplied from the hydraulic circuit 34 to the hydraulic motor 32 by controlling an electromagnetic control valve (not shown) or the like provided in the hydraulic circuit 34, thereby controlling the driving power generated by the hydraulic motor 32. The stator (stationary element) 60 of the hydraulic motor 32 is provided integrally with the case 44, and is rotated together with the propeller shaft 24 that is coupled to the case 44. Besides, an output gear 64 as a torque transfer gear is coupled to the rotor (rotary element) 62 of the hydraulic motor 32. The output gear 64 meshes with the inner pinions P_{IN} of the planetary gear device 46. In this construction, the inner pinions P_{IN} are rotationally driven by the driving power generated by the hydraulic motor 32.

Next, the distribution of driving power to the right and left rear wheels 30 by the driving power distribution device 26 constructed as described above will be described. The driving power generated by the engine 12 is input to the driving power distribution device 26 as driving power (rotational torque) that rotationally drives the case 44 of the differential device 38, via the automatic transmission 14, the central differential gear device 22, the propeller shaft 24, etc. Since the ring gear R of the planetary gear device 46 is provided integrally with the case 44, the driving power from the propeller shaft 24 is input from the ring gear R to the planetary gear device 46. As described above, the planetary gear device 46 is designed so that the gear ratio p=0.5. Therefore, when the hydraulic motor 32 is not driven (non-control time), the driving power input from the ring gear R is distributed equally to the carrier CA and the sun gear S. The driving power output from the carrier CA to the first speed reducer device 40 is first reduced in speed by the gear pair 48, and is further reduced in speed by the hypoid gear pair 50, and then is transmitted to the rear wheel 30r. Besides, the driving power output from the sun gear to the second speed reducer device 42 is first reduced in speed by the gear pair 52, and is further reduced in speed by the hypoid gear pair 54, and then is transmitted to the rear wheel 30l. In this manner, the driving power distribution device 26 basically functions as an ordinary open differential via the differential device 38, that is, carries out equal distribution of the driving power generated by the engine 12 to the right and left rear wheels 30 as driving wheels.

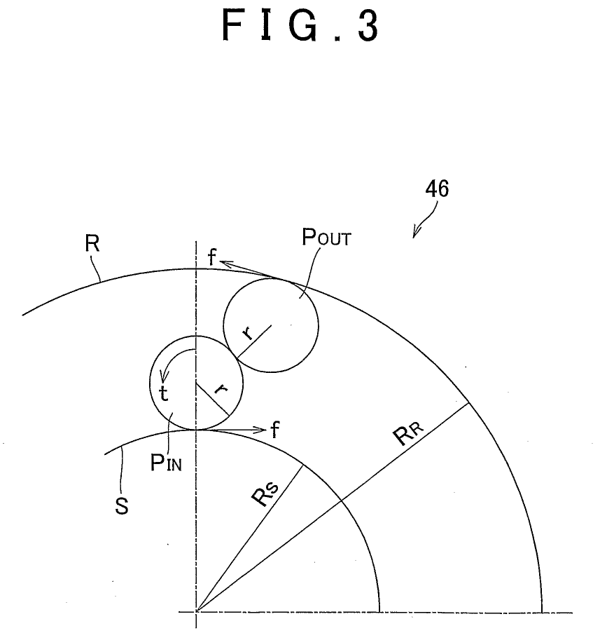

The driving power distribution device 26 is capable of performing, for example, a control of generating a desired torque difference between the right and left rear wheels 30 or restricting the differential motion therebetween via the planetary gear device 46 by using the driving power generated by the hydraulic motor 32. FIG. 3 is a diagram illustrating an action of generating a desired torque difference between the right and left rear wheels 30 via the planetary gear device 46 by using the driving power generated by the hydraulic motor 32 in the driving power distribution device 26. As shown in FIG. 3, when a predetermined torque t is applied to the inner pinions P_{IN} of the planetary gear device 46 from the hydraulic motor 32, a tangential force f acts, as a meshing reaction force against the torque t, from the pinions P made up of the inner pinions P_{IN} and the outer pinions P_{OUT}, to each of the sun gear S and the ring gear R. This tangential force f is expressed as in the following equation (1), where r is the radius of the pinions P. Besides, the torques T_{S}, T_{R} that act on the sun gear S and the ring gear R, respectively, are expressed as in the following equations (2) and (3), where R_{S} is the radius of the sun gear, and R_{R} is the radius of the ring gear, and N is the number of pinion sets.

The planetary gear device 46 is designed so that the gear ratio p=0.5, and therefore R_{S}:R_{R}=1:2. Besides, a torque T_{R}′ corresponding to the reaction force against the torque T_{R} acts on the ring gear R as an input member to which the driving power from the engine 12 is transmitted via the propeller shaft 24. The torque T_{R}′ is equally distributed as torques T_{S}′, T_{C}′ to the sun gear S and the carrier CA. Since the reaction torque T_{S}' that acts on the sun gear S balances the torque T_{S} that is applied to the sun gear S from outside, the reaction torque T_{C}′ that acts on the carrier CA is equal to the torque difference ΔT between the right and left rear wheels 30. Therefore, the following equation (4) holds. If the equation (4) is changed by using the equations (2) and (3), equation (5) can be obtained. In consequence, the torque difference ΔT between the right and left rear wheels 30 is equal to the torque applied to the inner pinions P_{IN}, that is, the torque applied from the hydraulic motor 32.

### EQUATION (1)

### EQUATION (2)

### EQUATION (3)

### EQUATION (4)

### EQUATION (5)

Furthermore, the driving power distribution device 26 can put the differential device 38 into a non-differential state by causing a braked state (a state in which the stator 60 and the rotor 62 cannot be rotated relatively to each other) by applying a brake force to the hydraulic motor 32. Thus, the differential motion between the right and left rear wheels 30 can be restricted. Specifically, when the hydraulic motor 32 is put into the braked state, the driving of the pinions P is stopped, bringing about a state where the planetary gear device 46 and the propeller shaft 24 rotate integrally together at equal rotation speeds. In this state, since the carrier CA and the sun gear S of the planetary gear device 46 are rotated at the same rotation speed, the differential motion between the right and left rear wheels 30r, 30l connected to the rotating elements of the planetary gear device 46 is restricted so that the right and left rear wheels 30r, 30l rotate at the same rotation speed (number of rotations).

The control device 36 selectively executes the aforementioned right-left wheel torque difference control, the aforementioned differential motion restriction control, etc., in accordance with the signals supplied form the various sensors, that is, the running state of the vehicle. Concretely, the control device 36 controls the distribution of driving power to the right and left rear wheels 30 via the driving power distribution device 26, by controlling the oil pressure that is supplied to the hydraulic motor 32 via an electromagnetic control valve (not shown) or the like provided in the hydraulic circuit 34 so as to control the driving direction and the driving power (rotational torque) of the hydraulic motor 32. That is, during a non-control state (non-control time), the hydraulic motor 32 is not driven, but the rotor 62 is allowed to rotate freely about its own axial center. Therefore, the differential device 38 functions as an ordinary open differential, and the driving power generated by the engine 12 is equally distributed to the right and left rear wheels 30r, 30l via the differential device 38.

During a right-left wheel torque difference control state (torque distribution time), the oil pressure output from the hydraulic circuit 34 is controlled so as to cause the hydraulic motor 32 to generate a predetermined driving power that causes generation of a predetermined torque difference between the right and left driving wheels 30. For example, in the case where the understeer is desired to be restrained during a right turn, the hydraulic motor 32 is caused to output counterclockwise driving torque to reduce the torque of the right rear wheel 30r, which is an inner turning wheel, and to increase the torque of the left rear wheel 30l, which is an outer turning wheel, so that a yaw moment that assists the turning motion about the center of gravity of the vehicle is given. In this manner, a suitable turn can be realized.

During a differential motion restriction control state (differential motion restricted time), the hydraulic motor 32 is put into the braked state where the stator 60 and the rotor 62 cannot be rotated relatively to each other, so that the differential device 38 is put into the non-differential state where the planetary gear device 46 is rotated integrally with the propeller shaft 24 at equal speed. Therefore, the differential motion of the right and left rear wheels 30r, 30l is restricted, and therefore the right and left rear wheels 30r, 30l are rotated at the same rotation speed. Incidentally, the differential motion restriction force is proportional to the brake torque of the hydraulic motor 32, and therefore can be arbitrarily set by controlling the oil pressure supplied to the hydraulic motor 32.

According to the first embodiment, the driving power distribution device 26 includes: the propeller shaft 24 as a driving power transmission shaft that transmits the driving power generated by the engine 12 as a driving power source and that is disposed so that the axis of rotation thereof is orthogonal to the axis of rotation of each of the right and left rear wheels 30 as driving wheels; the differential device 38 having the planetary gear device 46 that is made up mainly of the first rotating element, the second rotating element and the third rotating element and that is provided concentrically with the axial center of rotation of the propeller shaft 24; and a hydraulic motor 32 fixed to the propeller shaft 24. The first rotating element of the planetary gear device 46 is coupled to the propeller shaft 24, and the second rotating element thereof is connected to the right rear wheel 30r, and the third rotating element is connected to the left rear wheel 30l. The inner pinions P_{IN} of the planetary gear device 46 are driven by the driving power generated by the hydraulic motor 32. Therefore, while the driving power generated by the engine 12 is being distributed to the right and left rear wheels 30 via the differential device 38, a control of, for example, generating a desired torque difference between the right and left rear wheels 30 or restricting the differential motion therebetween by using the driving power generated by the hydraulic motor 32, can be performed. At the same time, the actuator torque capacity can be reduced, so that size reduction of the device is made possible. That is, the simply constructed vehicular driving power distribution device 26 capable of suitably distributing the driving power to the right and left rear wheels 30 can be provided.

Besides, in the planetary gear device 46, the first rotating element is the ring gear R, and the second rotating element is the carrier CA that supports a plurality of pinions P, and the third rotating element is the sun gear S. Therefore, while the driving power generated by the engine 12 is being distributed to the right and left rear wheels 30 via the differential device 38 constructed in a practical fashion, a control of, for example, generating a desired torque difference between the right and left rear wheels 30 or restricting the differential motion therebetween by using the driving power generated by the hydraulic motor 32, can be performed.

Besides, the planetary gear device 46 is a double-pinion type planetary gear device, and the hydraulic motor 32 drives the inner pinions P_{IN} of the planetary gear device 48. Therefore, while the driving power generated by the engine 12 is being distributed to the right and left rear wheels 30 via the differential device 38 constructed in a practical fashion, a control of, for example, generating a desired torque difference between the right and left rear wheels 30 or restricting the differential motion therebetween by using the driving power generated by the hydraulic motor 32, can be performed.

Besides, the carrier CA, which is the second rotating element, and the sun gear S, which is the third rotating element, are connected to the right and left rear wheels 30 via the first speed reducer device 40 and the second speed reducer device 42, respectively. Therefore, the driving powers distributed by the differential device 38 can be suitably transmitted to the right and left rear wheels 30.

Beside, since the speed reducer devices 40, 42 perform speed reduction via the hypoid gear pairs 50, 54, the driving powers distributed by the differential device 38 can be further suitably transmitted to the right and left rear wheels 30.

Besides, the speed reducer devices 40, 42 first performs speed reduction via the gear pairs 48, 52, and then further perform speed reduction via the hypoid gear pairs 50, 54. Therefore, the driving powers distributed by the differential device 38 can be further suitably transmitted to the right and left rear wheels 30.

Besides, the motor provided in the driving power distribution device 26 is the hydraulic motor 32 that is driven by the oil pressure supplied from the hydraulic pump 56 via the pressure control valve 58, the hydraulic circuit 34, etc. Therefore, a control of, for example, generating a desired torque difference between the right and left rear wheels 30 or restricting the differential motion therebetween by using the driving power generated by the practical hydraulic motor 32, can be performed.

Besides, since the torque distribution to the right and left rear wheels 30 can be controlled by controlling the driving power generated by the hydraulic motor 32, a desired torque difference can be generated between the right and left rear wheels 30 through a simple control.

Besides, since the differential motion between the right and left rear wheels 30 can be controlled by braking the hydraulic motor 32, the restriction of the differential motion between the right and left rear wheels 30 can be realized through a simple control.

Subsequently, a second embodiment of the invention will be described in detail with reference to the drawings. In the below description, portions common to the embodiments are given the same reference characters, and the description of those portions will be omitted.

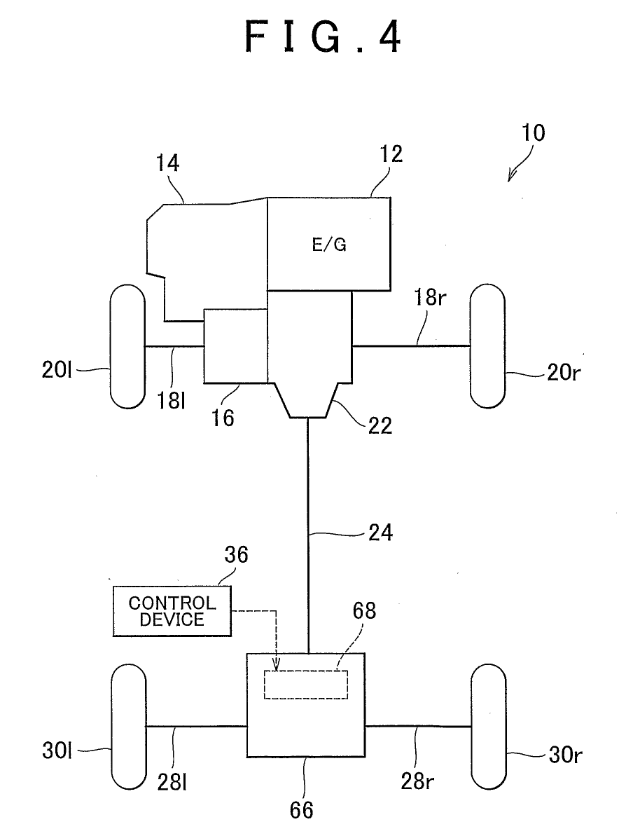

FIG. 4 is a skeleton diagram illustrating a construction of a front-rear-wheel drive vehicle that has a driving power distribution device 66 of a second embodiment of the invention. As shown in FIG. 4, the vehicular driving power distribution device (hereinafter, simply referred to as “driving power distribution device”) 66 of the second embodiment is preferably a device that is suitably applied to the driving power transmission device 10 described above with reference to FIG. 1, or the like. The driving power distribution device 66 includes an electric motor 68 that is driven by electric energy, as an alternative to the above-described hydraulic motor 32 in the driving power distribution device 26.

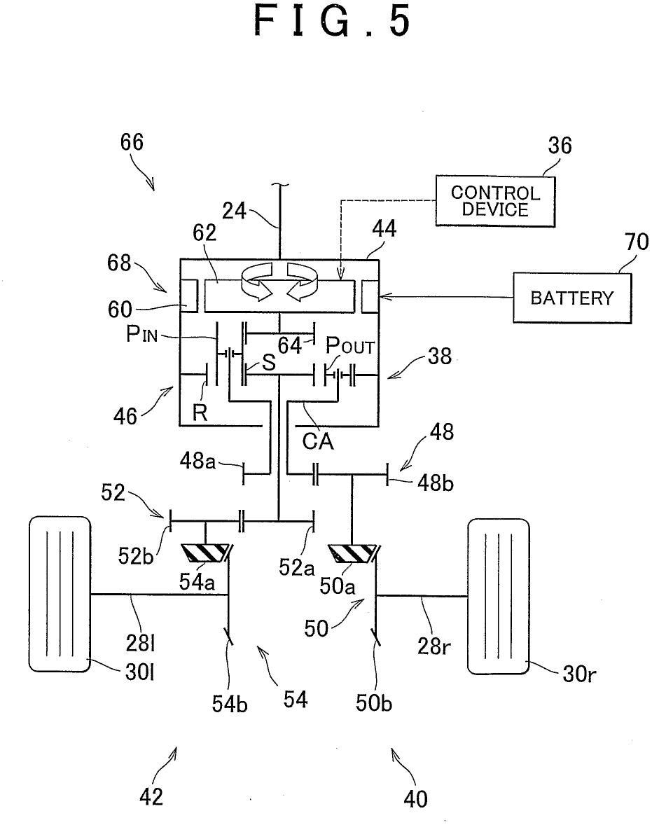

FIG. 5 is a skeleton diagram illustrating a construction of the driving power distribution device 66. As shown in FIG. 5, the electric motor 68 provided in the driving power distribution device 66 of the second embodiment is driven by the electric energy supplied from a battery 70 as a power supply device. Besides, the control device 36 electrically controls the driving power generated by the electric motor 68, by supplying a predetermined command signal to the electric motor 68. The driving power distribution device 66 constructed as described above also can realize the differential motion control as an ordinary differential unit, and the torque difference control, the differential motion restriction control, etc., similarly to the driving power distribution device 26 described above with reference to FIG. 2.

Thus, since the motor provided in the driving power distribution device 66 of the second embodiment is the electric motor 68 that is driven by the electric energy supplied from the battery 70, a control of, for example, generating a desired torque difference between the right and left rear wheels 30 or restricting the differential motion therebetween by using the driving power generated by the practical electric motor 68, can be performed. Besides, the electric motor 68 can make impossible the relative rotation between the stator 60 and the rotor 62 by the regenerative braking. Therefore, the differential motion between the right and left rear wheels 30 can easily be restricted by the driving power distribution device 66.

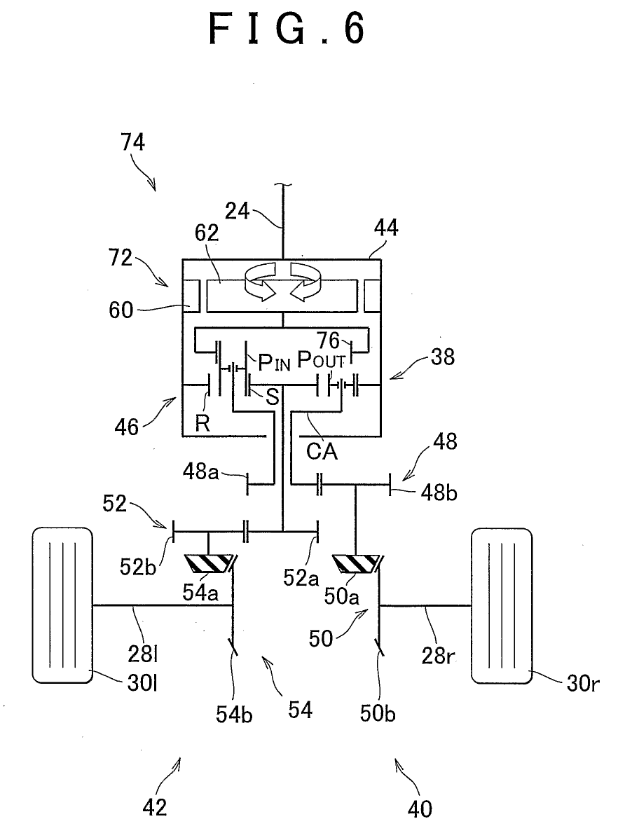

FIG. 6 is a skeleton diagram illustrating a construction of a driving power distribution device of a third embodiment of the invention. The driving power distribution device shown in FIG. 6 is provided with a motor for making possible the control of, for example, generating a desired torque difference between the right and left rear wheels 30 or restricting the differential motion therebetween, similarly to the driving power distribution devices 26, 66, and this motor may be either the hydraulic motor 32 or the electric motor 68. In the following description, the motor will be simply referred to as “motor 72”, and the description thereof will be omitted.

In the driving power distribution device 74 shown in FIG. 6, in place of the output gear 64 coupled to the motor 72 in the construction described above with reference to FIG. 2 and the like, an output gear 76 that is an internal gear and is employed as a torque transfer gear is coupled to the output shaft of the motor 72, and meshes with the inner pinions P_{IN} of the planetary gear device 46. In this construction, too, the inner pinions P_{IN} are rotationally driven by the driving power generated by the motor 72, and therefore the differential motion control as an ordinary differential unit, the torque difference control, the differential motion restriction control, etc., can be realized, similarly to the above-described driving power distribution device 26, and the like.

While the preferred embodiments of the invention have been descried in detail with reference to the drawings, the invention is not limited to these embodiments, but is also carried out in other fashions.

For example, although in the foregoing embodiments, the driving power distribution device 26 or the like is applied to a front-rear-wheel drive vehicle that is based on a front-mounted engine front wheel drive system, the invention is not limited thereto, but is appropriately applicable to various types of vehicles such as front-mounted engine front wheel drive (FF) vehicles, front-mounted engine rear wheel drive (FR) vehicles, front-rear-wheel drive vehicles that are based on a front-mounted rear wheel drive system, etc.

Furthermore, although in the foregoing embodiments, the driving power distribution device 26 or the like controls the distribution of the driving power to the right and left rear wheels 30r, 30l as driving wheels, a construction in which the distribution of the driving power to the right and left front wheels 20r, 20l as driving wheels is controlled is also well conceivable. Besides, in a front-rear-wheel drive vehicle, separate driving power distribution devices may be provided corresponding to the front wheels and the rear wheels.

Furthermore, although in the foregoing embodiments, the differential device 38 includes the double-pinion type planetary gear device 46 as a component element, a differential device is appropriate if it includes a planetary gear device that is made up mainly of the first rotating element, the second rotating element and the third rotating element; for example, a differential device including a single-pinion type planetary gear device is also allowable.

Furthermore, although in the foregoing embodiments, the speed reducer devices 40, 42 or the like perform speed reduction via the hypoid gear pairs 50, 54, speed reducer devices that perform speed reduction via bevel gear pairs or the like are well allowable.

Furthermore, although in the foregoing embodiments, the control device 36 selectively executes the right-left wheel torque difference control, the differential motion restriction control, etc., in accordance with the signals supplied form the various sensors, that is, in accordance with the running state of the vehicle, it is allowable to provide a construction in which a driver can select one of the controls using a switch or the like.

Still further, although not individually exemplified, various modifications are made in carrying out the invention, without departing from the sprit of the invention.

1. A vehicular driving power distribution device that distributes driving power generated by a driving power source to right and left driving wheels comprising:
a driving power transmission shaft that transmits the driving power generated by the driving power source and that is disposed so that an axis of rotation of the driving power transmission shaft is orthogonal to an axis of rotation of each of the right and left driving wheels;
a differential device having a planetary gear device that has a first rotating element, a second rotating element and a third rotating element and that is provided concentrically with an axial center of rotation of the driving power transmission shaft; and
a motor fixed to the driving power transmission shaft,
wherein the first rotating element of the planetary gear device is coupled to the driving power transmission shaft, and the second rotating element is connected to one of the right and left driving wheels, and the third rotating element is connected to another one of the right and left driving wheels, and pinions of the planetary gear device are driven by driving power generated by the motor.

2. The vehicular driving power distribution device according to claim 1, wherein
in the planetary gear device, the first rotating element is a ring gear, and the second rotating element is a carrier that supports a plurality of pinions, and the third rotating element is a sun gear.

3. The vehicular driving power distribution device according to claim 2, wherein
the planetary gear device is a double-pinion type planetary gear device, and the motor drives inner pinions that constitute the pinions of the planetary gear device.

4. The vehicular driving power distribution device according to claim 3, wherein
rotor of the motor is coupled to an output gear, and the output gear drives the inner pinions.

5. The vehicular driving power distribution device according to claim 4, wherein
the output gear is an external gear.

6. The vehicular driving power distribution device according to claim 4, wherein
the output gear is an internal gear.

7. The vehicular driving power distribution device according to claim 1, wherein
the second rotating element and the third rotating element are connected to the right and left driving wheels via speed reducer devices respectively.

8. The vehicular driving power distribution device according to claim 7, wherein
each speed reducer device performs speed reduction via a hypoid gear pair.

9. The vehicular driving power distribution device according to claim 7, wherein
each speed reducer device performs speed reduction via a gear pair, and then further performs speed reduction via a hypoid gear pair.

10. The vehicular driving power distribution device according to claim 1, wherein
the motor is a hydraulic motor.

11. The vehicular driving power distribution device according to claim 1, wherein
the motor is an electric motor.

12. The vehicular driving power distribution device according to claim 1, wherein
torque distribution to the right and left driving wheels is controlled by controlling the driving power generated by the motor.

13. The vehicular driving power distribution device according to claim 1, wherein
differential motion between the right and left driving wheels is restricted by braking the motor.

14. The vehicular driving power distribution device according to claim 1, wherein
the planetary gear device is a double-pinion type planetary gear device, and the motor drives inner pinions that constitute the pinions of the planetary gear device.

15. The vehicular driving power distribution device according to claim 14, wherein
a rotor of the motor is coupled to an output gear, and the output gear drives the inner pinions.

16. The vehicular driving power distribution device according to claim 15, wherein
the output gear is an external gear.

17. The vehicular driving power distribution device according to claim 15, wherein
the output gear is an internal gear.
